(19) United States
(12) Patent Application Publication
(10) Pub. No.: US 2011/0232003 A1
(43) Pub. Date: Sep. 29, 2011

(54) IMPROVEMENTS RELATING TO FABRIC CONDITIONING COMPOSITIONS

(76) Inventors: Paul Anthony Anderson, Sharnbrook (GB); Tamara Marie Ross, Wirral (GB)

(21) Appl. No.: 13/132,957

(22) PCT Filed: Nov. 26, 2009
(86) PCT No.: PCT/EP2009/065881

§ 371 Date: Jun. 6, 2011

(30) Foreign Application Priority Data
Dec. 10, 2008 (EP) 08171246.5

(51) Int. Cl. B67D 7/16; D06M 23/02; B65D 35/56; B65D 85/00

(52) U.S. Cl. 8/137; 222/105; 206/524.1; 222/71

(57) ABSTRACT

A packaged fabric conditioning product comprising a flowable fabric conditioning composition comprising 0.5-40% by weight of at least one unsaturated quaternary ammonium compound, said composition contained in bottom-dispensing packaging which comprises (i) a deformable container in which the fabric conditioning composition is stored with ullage; and (ii) a dispensing device which is located at the base of the container such that in the inverted position the flowable fabric conditioning composition is positioned beneath the ullage and above the dispensing device.

The present invention relates to fabric conditioning compositions comprising unsaturated quaternary ammonium compounds and packaging therefore.

Quaternary ammonium compounds provide effective fabric conditioning agents. Unsaturated forms are particularly advantageous (as compared with saturated forms) due to the increased formulation flexibility offered. Unsaturated quaternary ammonium compounds allow more freedom in the selection of perfume within a fabric conditioning composition than their saturated counterparts. The unsaturated compounds are also cheaper.

However such unsaturated quaternary ammonium compounds suffer the disadvantage that they decompose (rancidify) when exposed to air with resultant discolouration and malodour.

Fabric conditioning liquid formulations are stored in bottles with screw-top lids. Each time these bottles are opened, the ullage (the air above the contained liquid), may be totally replaced so that a fresh supply of oxygen-rich air is supplied thereby exacerbating the rancidification process.

An object of the invention is therefore to provide a packaged fabric conditioning composition which offers formulation flexibility together with improved protection against rancidification.

Accordingly in a first aspect, the invention provides a packaged fabric conditioning product comprising a flowable fabric conditioning composition comprising 0.5-40% by weight of at least one unsaturated quaternary ammonium compound, said composition contained in bottom-dispensing packaging which comprises
(i) a deformable container in which the fabric conditioning composition is stored with ullage; and
(ii) a dispensing device which is located at the base of the container such that in the inverted position the flowable fabric conditioning composition is positioned beneath the ullage and above the dispensing device.

The term “ullage” as used herein, is intended to mean the volume (containing gas and/or vapour) above the flowable composition. The ullage will increase during use, as the composition is used up by the consumer.

The invention is advantageous as gravity forces the flowable composition to be positioned between the ullage and the dispensing device. Thus, dispensing of the fabric conditioning composition, via the dispensing device, results in egress of the composition followed by ingress of only that volume of air which is necessary to replace the volume of composition dispensed and equalise the pressure. There is no complete refreshing of the ullage. Thus, the amount of oxygen rich air which can contact and rancidify the composition is limited.

Preferably the dispensing device is enclosed by a closure device which also provides a supportive base of the package. The closure device or dispensing device may also comprise a dosing device, for dosing the composition.

The package may comprise a squeeze actuated container. Preferably the squeeze-actuated container comprises a resiliently deformable material.

The dispensing device preferably comprises an orifice in fluid communication with the stored fabric conditioning composition, and more preferably a this orifice comprises a valve through which dispensing may occur.

The valve may be a pressure-responsive dispensing valve that controls the flow according to a pressure difference across the valve. Such a valve can be configured to be normally closed and to assume an open configuration only when the container is squeezed. Bottom dispensing containers of rigid materials having pump mechanisms are also suitable for use herein.

The valve may comprise a slit valve. The slit valve preferably comprises a flexible material with higher flexibility relative to that of the surrounding structure. The slit valve accordingly may comprise silicone rubber, polyvinyl chloride, urethane, ethylene vinyl acetate, a styrene-butadiene copolymer, and combinations thereof. When the container is in an upright position (i.e. with the dispensing device at the base, as shown in the drawing herein) and the container squeezed, the slit valve opens due to the increased pressure and the flowable fabric conditioning composition egresses via the slit. Upon removal of the squeezing force, the slit closes and the no further egress is allowed. The stiffness of the slit valve is selected to prevent the slit from open unless the applied pressure exceeds the hydraulic static head pressure generated when the container is filled with the fabric conditioning composition.

The slit valve may comprise a membrane with one or more slits. The membrane may comprise an arcuate portion in which the slit or slits are connected. In the case of a plurality of slits, they may be interconnecting. The slit or slits may define leaves which bend on pressure (e.g. when the container is squeezed) to allow the fabric conditioning composition to pass through. The slits may define a plurality of generally triangular leaves.

When the dispensing pressure is released, the leaves spring back to their original position and operate to block passage of product through the dispensing orifice. The leaves of the valve are preferably sufficiently resilient that they do not bend open unless the applied pressure exceeds the hydraulic static head pressure generated when the container is filled with the fabric conditioning composition.

The package may have a curved top to deter users from storing the bottle top-down. In this way the package is more likely to be stored in a pretreater-loading position i.e. with the flowable laundry composition accumulated by gravity in the base of the package.

The bottom dispensing container may comprise a polymeric material selected from polypropylene (PP), polyethylene (PE), polycarbonate (PC), polyamides (PA) polyethylene terephthalate (PET), polyvinylchloride (PVC), polystyrene (PS), and combinations thereof.

In a further aspect the invention provides a process for conditioning a fabric by treating the fabric with a flowable fabric conditioning composition comprising 0.5-40% by weight of at least one unsaturated quaternary ammonium compound using the product according to the first aspect, the process including the step of squeezing the inverted container to dispense the composition.

The process for conditioning a may comprise the step of squeezing the container is preceded by inverting the package such that the dispenser is beneath the stored composition.

The process for storing a fabric conditioning product may comprise the step of inverting the package such that the dispenser is beneath the stored composition.

However it is preferred that the packaged fabric conditioning product incorporates visible or tactile indicia to guide the consumer to store the package in the inverted position wherein the flowable fabric conditioning composition is positioned beneath the ullage and above the dispensing device.

### Fabric Conditioning Composition

All percentages, unless indicated otherwise, are intended to be percentages by weight.

Compositions with higher levels of unsaturated quaternary ammonium compounds are more prone to such disadvantages. Accordingly the fabric conditioning composition preferably comprises 1-40% by weight, more preferably 30-40% by weight of the unsaturated quaternary ammonium compound.

The fabric treatment composition of the invention is suitable for use in a laundry process. Examples include a softening-in-the-wash main wash composition, a rinse treatment (e.g. conditioner or finisher), or a post-treatment ‘wet tissue’ type product. The compositions of the present invention are preferably laundry compositions, especially softening-in-the-wash compositions or rinse-added softening compositions.

The compositions of the invention may be in any physical form e.g. a solid such as a powder or granules, a tablet, a solid bar, a paste, gel or liquid, especially, an aqueous based liquid, spray, stick, impregnated substrates, foam or mousse. In particular the compositions may be liquid, powder, or unit dose such as tablet laundry compositions.

The liquid products of the invention may have pH ranging from 2.5 (for fabric care compositions) to 12 (for fabric softening-in-the-wash compositions). This pH range preferably remains stable over the shelf life of the product.

### The Quaternary Ammonium Compound

The quaternary ammonium fabric softening material for use in compositions of the present invention can be an ester-linked triethanolamine (TEA) quaternary ammonium compound comprising a mixture of mono-, di- and tri-ester linked components.

Typically, TEA-based fabric softening compounds comprise a mixture of mono, di- and tri-ester forms of the compound where the di-ester linked component comprises no more than 70% by weight of the fabric softening compound, preferably no more than 60%, e.g. no more than 55%, or even no more than 45% of the fabric softening compound and at least 10% of the monoester linked component by weight of the fabric softening compound.

A first group of quaternary ammonium compounds (QACs) suitable for use in the present invention is represented by formula (I):

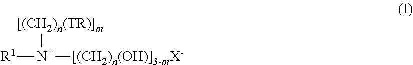

wherein each R is independently selected from a C₅₋₃₅ alkyl or alkenyl group; R¹ represents a C₁₋₄ alkyl, C₂₋₄ alkenyl or a C₁₋₄ hydroxyalkyl group; T is generally O—CO. (i.e. an ester group bound to R via its carbon atom), but may alternatively be CO—O (i.e. an ester group bound to R via its oxygen atom); n is a number selected from 1 to 4; m is a number selected from 1, 2, or 3; and X⁻ is an anionic counter-ion, such as a halide or alkyl sulphate, e.g. chloride or methylsulphate. Di-esters variants of formula I (i.e. m=2) are preferred and typically have mono- and tri-ester analogues associated with them. Such materials are particularly suitable for use in the present invention.

Especially preferred agents are di-esters of triethanolamine methylsulphate, otherwise referred to as “TEA ester quats.”. Commercial examples include Prapagen TQ (ex Clariant), Tetranyl L1-90 (ex Kao), Stepantex VT-90 and VK-90 (ex Stepan), Rewoquat WE18 (ex Evonik) all di-[partially hardened tallow ester] of triethanolamine methylsulphate). Preferred are Au57 ex Cognis and Stepantex SP-90 both (di-[palm ester] of triethanolamine methylsulphate).

The second group of QACs suitable for use in the invention is represented by formula (II):

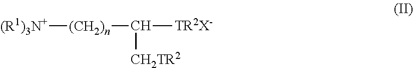

wherein each R¹ group is independently selected from C₁₋₄ alkyl, hydroxyalkyl or C₂₋₄ alkenyl groups; and wherein each R² group is independently selected from O₈₋₂₈ alkyl or alkenyl groups; and wherein n, T, and X⁻ are as defined above.

Preferred materials of this second group include 1,2 bis[tallowoyloxy]-3-trimethylamine propane chloride, 1,2 bis[hardened tallowoyloxy]-3-trimethylamine propane chloride, 1,2-bis[oleoyloxy]-3-trimethylamine propane chloride, and 1,2 bis[stearoyloxy]-3-trimethylamine propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

(R¹)₂—N⁺—[(CH₂)ₙ-T-R²]₂X⁻ (III)

wherein each R¹ group is independently selected from C₁₋₄ alkyl, or C₂₋₄ alkenyl groups; and wherein each R² group is independently selected from C₈₋₂₈ alkyl or alkenyl groups; and n, T, and X⁻ are as defined above. Preferred materials of this third group include bis(2-tallowoyloxyethyl)dimethyl ammonium chloride and hardened versions thereof. A commercial example of this material is Armosoft DEQ (ex AKZO).

The iodine value of the quaternary ammonium fabric softening material is preferably from 20 to 60, more preferably from 20 to 40.

Iodine value is defined as the number of grams of iodine absorbed per 100 g of test material.

Iodine value as used in the context of the present invention refers to the measurement of the degree of unsaturation present in a material by a method of nmr spectroscopy as described in Anal. Chem., 34, 1136 (1962) Johnson and Shoolery.

Iodine value is defined as the number of grams of iodine absorbed per 100 g of the test material. Olefinic materials absorb 1 gram of iodine per atom of olefinic hydrogen. Hence measurement can be converted to the equivalent Iodine Value. The hydrogen nmr spectrum at 360 MHz is obtained for the test material. The integral intensity, Iₛ, of the band derived from olefinic hydrogen in the alkyl chain and the integral intensity, Iₘ, of the band derived from terminal methyl groups in the alkyl chains are measured.

The number of olefinic hydrogens per molecule is given by:

Iₐ×6

Iₘ

and the Iodine Value is given by:

$$\frac{{I}_{s} \times 127 \times 100 \times 6}{{I}_{m} \times MMW}$$

where MMW is the mean molecular weight of the test material.

The non-ester softening compound preferably has the alkyl or alkenyl chain lengths referred to above for the non-ester softening compound. One preferred type of non-ester softening compound is a quaternary ammonium material represented by formula (IV):—

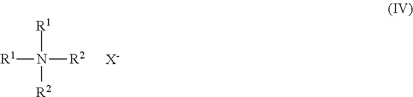

wherein each R¹ group is independently selected from C₁₋₄ alkyl, hydroxyalkyl or C₂₋₄ alkenyl groups; R² group is independently selected from C₈₋₂₈ alkyl or alkenyl groups, and X⁻ is as defined above.

The compositions may alternatively or additionally contain nonionic fabric softening agents such as lanolin and derivatives thereof. A further nonionic fabric softening agent suitable for use in the compositions of the invention is Castor oil, for example, from Now Chemicals.

Lecithins and other phospholipids are also suitable softening compounds. In fabric softening compositions nonionic stabilising agent may be present. Suitable nonionic stabilising agents may be present such as linear C8 to C22 alcohols alkoxylated with 10 to 20 moles of alkylene oxide, C10 to C20 alcohols, or mixtures thereof. Other stabilising agents include the deflocculating polymers as described in EP 0415698A2 and EP 0458599 B1.

Advantageously the nonionic stabilising agent is a linear C8 to C22 alcohol alkoxylated with 10 to 20 moles of alkylene oxide. Preferably, the level of nonionic stabiliser is within the range from 0.1 to 10% by weight, more preferably from 0.5 to 5% by weight, most preferably from 1 to 4% by weight. The mole ratio of the quaternary ammonium compound and/or other cationic softening agent to the nonionic stabilising agent is suitably within the range from 40:1 to about 1:1, preferably within the range from 18:1 to about 3:1.

The composition can also contain fatty acids, for example C8 to C24 alkyl or alkenyl monocarboxylic acids or polymers thereof. Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated compositions may comprise from 0.5 to 20% by weight of fatty acid, more preferably 1% to 10% by weight. The weight ratio of quaternary ammonium material or other cationic softening agent to fatty acid material is preferably from 10:1 to 1:10.

It is also possible to include certain mono-alkyl cationic surfactants which can be used in main-wash compositions for fabrics. Cationic surfactants that may be used include quaternary ammonium salts of the general formula R1R2R3R4N⁺ X⁻ wherein the R groups are long or short hydrocarbon chains, typically alkyl, hydroxyalkyl or ethoxylated alkyl groups, and X is a counter-ion (for example, compounds in which R1 is a C8-C22 alkyl group, preferably a C8-C10 or C12-C14 alkyl group, R2 is a methyl group, and R3 and R4, which may be the same or different, are methyl or hydroxyethyl groups); and cationic esters (for example, choline esters).

Softening in the wash compositions in accordance with the invention comprise a surface-active compound, selected from anionic surfactants, cationic surfactants, non-ionic surfactants, zwitterionic surfactants, amphoteric surfactants and mixtures thereof. The choice of surface-active compound (surfactant), and the amount present, will depend on the intended use of the detergent composition. In fabric washing compositions, different surfactant systems may be chosen, as is well known to the skilled formulator, for handwashing products and for products intended for use in different types of washing machine.

The total amount of surfactant present will also depend on the intended end use and may be as high as 60 wt %, for example, in a composition for washing fabrics by hand. In compositions for machine washing of fabrics, an amount of from 5 to 40 wt % is generally appropriate. Typically the compositions will comprise at least 2 wt % surfactant e.g. 2-60%, preferably 15-40% most preferably 25-35%, by weight of the composition.

The fabric conditioning compositions of the invention can also contain adjuvants that are normal in the cosmetic, pharmaceutical and/or dermatological field, such as hydrophilic or lipophilic gelling agents, hydrophilic or lipophilic active agents, preserving agents, antioxidants, solvents, fragrances, fillers, screening agents, bactericides, odour absorbers, photobleaches (singlet oxygen or radical type) and dyestuffs. The amounts of these various adjuvants are those conventionally used in the field under consideration and are, for example, from 0.01 to 20% of the total weight of the composition. Depending on their nature, these adjuvants can be introduced into the fatty phase and/or into the aqueous phase. Examples of suitable biocides for use in the present invention include Proxel (1,2-benzisothiazolin-3-one), available from, for example, Univar, Avecia and Uniqema; and Kathon CG (Methylchloroisothiazolinone and Methylisothiazolinone), available from Rhom and Haas.

Various non-limiting embodiments of the invention will now be more particularly described with reference to the following FIGURES in which:

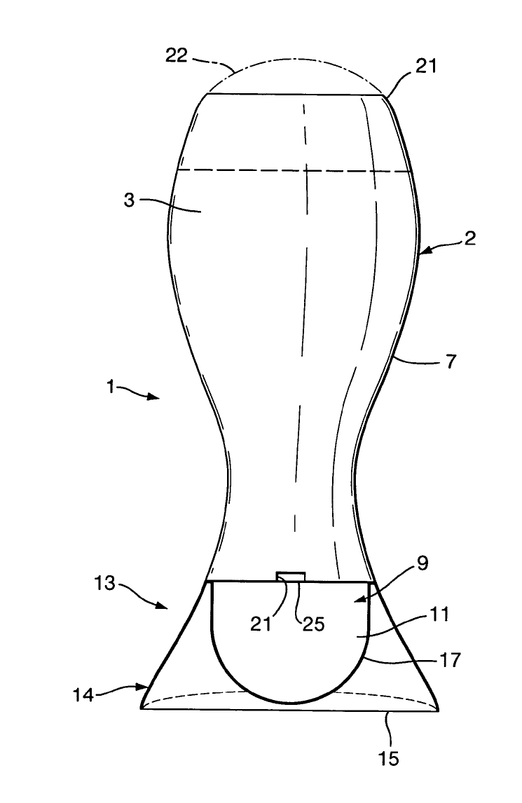

FIG. 1 shows a side view of a package according to the invention.

Referring to the drawings, a packaged fabric conditioning composition 1 is shown. The package 2 contains a liquid fabric conditioning composition (indicated at 3) comprising unsaturated quaternary ammonium compounds which may be according to any of the examples hereinbelow.

The package comprises a compressible container, in this example a plastic bottle 7 storing the flowable fabric conditioning composition 3 and a dispensing device 9. The dispensing device 9 is located at the base 13 of the container 7 and is enclosed by a dosing closure device 14. The closure 15 comprises the supportive base 13 of the package 2.

The bottle 7 and dispensing device 9 are attached to each other by threaded connection. The closure 14 is attached to the bottle also by a threaded or snap-fit connection. (connections not shown).

The bottle 7 is fabricated from a flexible plastic material comprising polyethylene terephthalate.

The top 21 of the bottle is shown flat but in other embodiments it may be curved as shown in dotted line 22 to discourage storage top-down.

The closure 14 includes an enlarged (with respect to at least the neck region of the bottle) flat, generally planar bottom surface 15. By providing an enlarged flat top surface 15, the surface allows the closure 14 to function as a supportive base 13 when the bottle is in the inverted position (as shown in the drawing) thereby forcing the fabric conditioning composition to accumulate (under gravity) at the dispensing device 9.

In addition, the closure 14 includes a reservoir portion 17. The closure is taped outwardly toward the surface 15 to provide a stable base. The area of the surface 15 is greater than that of the top 21 of the device.

The dispensing device 9 comprises an orifice through which dispensing may occur. The orifice includes a valve 21 comprising a membrane extending across an orifice 25 in the dispensing part 9.

In one embodiment, the membrane has an arcuate portion (not shown) directed toward the container 7. The arcuate portion of the membrane is provided with a intersecting slits to define a plurality of generally triangular leaves. When contents of the container are pressurized for dispensing, the triangular leaves bend toward the open end of the orifice 25 allowing product to pass through the orifice 25. When the dispensing pressure is released, the triangular leaves spring back to their original position and operate to block passage of product through the orifice 25. The leaves of the valve are sufficiently resilient that they do not bend open unless the applied pressure exceeds the hydraulic static head pressure generated by a full of condiment.

### Non-Limiting Examples of Fabric Conditioning Compositions According to Embodiments of the Invention as Described Above.

Unless stated otherwise, all proportions are given in weight percent by weight of the total composition.

### Exemplary: Fabric Conditioner Compositions 1, 2 and 3

| Composition | 1 | 2 | 3 |
|---|---|---|---|
| Softener | | | |
| Soft TEA Quat* | 16.5 | 10 | 16.5 |
| Fatty alcohol** | — | 0.5 | |
| Other components | | | |
| Electrolyte (CaCl2) | 0.015 | 0.015 | 0.015 |
| Perfume | 1.00 | 1.00 | 1.00 |
| Water | to 100 | to 100 | to 100 |

*Soft TEA quat is a cationic softener based on triethanolamine with tallow and 15% IPA as solvent. Compositions 1 and 2: (VT-90 ex Stepan) Composition 3: Soft DEEDMAC (Armosoft DEQ ex Akzo)
**C16C18 fatty alcohol (Hydrenol D ex Cognis)

It is of course to be understood that the invention is not intended to be restricted to the details of the above embodiment which are described by way of example only.

1. A packaged fabric conditioning product comprising a flowable fabric conditioning composition comprising 0.5-40% by weight of at least one unsaturated quaternary ammonium compound, said composition contained in bottom-dispensing packaging which comprises
(i) a deformable container in which the fabric conditioning composition is stored with ullage; and
(ii) a dispensing device which is located at the base of the container such that in the inverted position the flowable fabric conditioning composition is positioned beneath the ullage and above the dispensing device.

2. A packaged fabric conditioning product according to claim 1 wherein the dispensing device is enclosed by a closure device which also provides a supportive base of the package.

3. A packaged fabric conditioning product according to claim 2 wherein the closure device or the dispensing device comprises a dosing device, for dosing the composition.

4. A packaged fabric conditioning product according to claim 1 wherein the container is a squeeze actuated container.

5. A packaged fabric conditioning product according to claim 1 wherein the dispensing device comprises an orifice in fluid communication with the stored fabric conditioning composition, and more preferably a this orifice comprises a valve through which dispensing may occur.

6. A packaged fabric conditioning product according to claim 1 wherein the valve is a pressure-responsive dispensing valve that controls the flow according to a pressure difference across the valve, such as a slit valve.

7. A packaged fabric conditioning product according to claim 1 incorporating visible or tactile indicia to guide the consumer to store the package in the inverted position wherein the flowable fabric conditioning composition is positioned beneath the ullage and above the dispensing device.

8. A packaged fabric conditioning product according to claim 1 wherein the at least one unsaturated quaternary ammonium compound comprises an ester-linked triethanolamine (TEA) quaternary ammonium compound comprising a mixture of mono-, di- and tri-ester linked components.

9. A packaged fabric conditioning product according to claim 1 wherein the iodine value of the quaternary ammonium fabric compound is from 20 to 60.

10. A process for conditioning a fabric by treating the fabric with a flowable fabric conditioning composition comprising 0.5-40% by weight of at least one unsaturated quaternary ammonium compound using the product according to claim 1, the process including the step of squeezing the inverted container to dispense the composition.

11. A process for conditioning a fabric according to claim 10 wherein the step of squeezing the container is preceded by inverting the package such that the dispenser is beneath the stored composition.

12. A process for storing a fabric conditioning product according to claim 1 comprising the step of inverting the package such that the dispenser is beneath the stored composition.

13. A packaged fabric conditioning product substantially as hereinbefore described with reference to and/or as illustrated in the accompanying drawings.
